(19) United States
(12) Patent Application Publication
(10) Pub. No.: US 2025/0295968 A1
(43) Pub. Date: Sep. 25, 2025

(54) PICKLEBALL PADDLE HOLDER

(71) Applicant: Ofinno, LLC, Reston, VA (US)

(72) Inventor: Esmael Hejazi DINAN, McLean, VA (US)

(21) Appl. No.: 19/086,109

(22) Filed: Mar. 20, 2025

Related U.S. Application Data
(60) Provisional application No. 63/567,938, filed on Mar. 20, 2024.

(51) Int. Cl. A63B 60/58; A63B 102/08; B65G 1/10

(52) U.S. Cl. CPC A63B 60/58; B65G 1/10; A63B 2102/08; B65G 2203/0233

(57) ABSTRACT

This disclosure describes pickleball paddle holders. An example standalone pickleball paddle holding system comprises a movable surface with a plurality of pickleball paddle hold structures. The movable surface is configured to move between two fixed end objects. Example standalone pickleball paddle holding systems may provide a “table” look-and-feel that is similar to existing pickleball holders. In some examples, the systems are portable.

### CROSS REFERENCE TO RELATED APPLICATIONS

This application claims priority from U.S. Provisional Application No. 63/567,938 filed Mar. 20, 2024, the entire disclosure of which is incorporated by reference in its entirety.

### FIELD

This disclosure relates to pickleball paddle holders.

### BACKGROUND

Pickleball is a sport that is rapidly gaining popularity among many segments of the population. Pickleball courts are often crowded even for recreational play, with sets of players waiting to play. In many tournament settings, sets of players are assigned to courts and with games typically only taking 20-30 minutes apiece, it is often the case that several sets of players line up for the same court or set of courts. Each set of players may have two or four players, depending on whether singles or doubles play is taking place.

In order to have an orderly way of ensuring players are provided with a fair opportunity to play the game, the paddles of players are kept arranged in the order of arrival (e.g., assuming a first come first served order). But as the courts become busier, maintaining such an arrangement throughout long periods become cumbersome and subject to error. Therefore, improved apparatuses for arranging pickleball paddles are desired.

### SUMMARY OF EXAMPLE EMBODIMENTS

According to an example embodiment a standalone pickleball paddle holding system is provided. The system comprises a movable surface with a plurality of pickleball paddle hold structures formed on the movable surface. The movable surface is configured to move between two fixed end objects, and the pickleball paddle hold structures in an upper portion of the movable surface that is above and between the two fixed end objects are each configured to hold a respective pickleball paddle such that at least a majority of the respective pickleball paddle is positioned between the lateral edges of the upper portion of the movable surface.

### BRIEF DESCRIPTION OF THE DRAWINGS

Some features are shown by way of example, and not by limitation, in the accompanying drawings. In the drawings, like numerals may reference similar elements.

FIG. 1A shows an example pickleball court, in which embodiments of the present disclosure may be applied.

FIG. 1B shows another view of a pickleball court.

FIG. 2 shows a conventional pickleball paddle holder.

FIG. 3 shows a pickleball paddle holder having a movable surface, in accordance with some embodiments of the present disclosure.

FIG. 4 shows another pickleball paddle holder having a movable surface, in accordance with some embodiments of the present disclosure.

FIG. 5 shows a pickleball paddle holder with paddle holding structures formed on the movable surface, according to some embodiments of the present disclosure.

FIG. 6 shows a pickleball paddle holder with a paddle holding structure enabling paddle occupancy to be monitored by a sensor, according to some embodiments of the present disclosure.

FIG. 7 shows a pickleball paddle holder with a paddle holding structure enabling paddle occupancy to be monitored by a first type of sensor, according to some embodiments of the present disclosure.

FIG. 8 shows a pickleball paddle holder with a paddle holding structure enabling paddle occupancy to be monitored by a second type of sensor, according to some embodiments of the present disclosure.

FIG. 9 shows a pickleball paddle holder with a paddle holding structure enabling paddle occupancy to be monitored using a spring loaded protruding object and a sensor, according to some embodiments of the present disclosure.

FIG. 10 shows a pickleball paddle holder with a motorized end roller, according to some embodiments of the present disclosure.

FIG. 11 shows a pickleball paddle holder similar to that of FIG. 3 and providing more paddle holding space, according to some embodiments of the present disclosure.

### DETAILED DESCRIPTION OF EXAMPLE EMBODIMENTS

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

This disclosure relates to “Pickleball,” a game that has in recent years seen a massive increase in popularity among all age groups of players, including among senior citizens. Pickleball is a game that can be described as combining aspects of tennis, badminton, and ping-pong. It is played on a badminton-sized court, with paddles and a ball similar to a wiffle ball, but slightly smaller in size. The net used in pickleball is similar to a tennis net in some ways, but is lowered at the center.

Pickleball has recently become very popular and is played both indoors and outdoors, as either doubles or singles. The rules are relatively simple and the game is easy for beginners to learn. However, among skilled players, pickleball can develop into a quick, fast-paced, and competitive game.

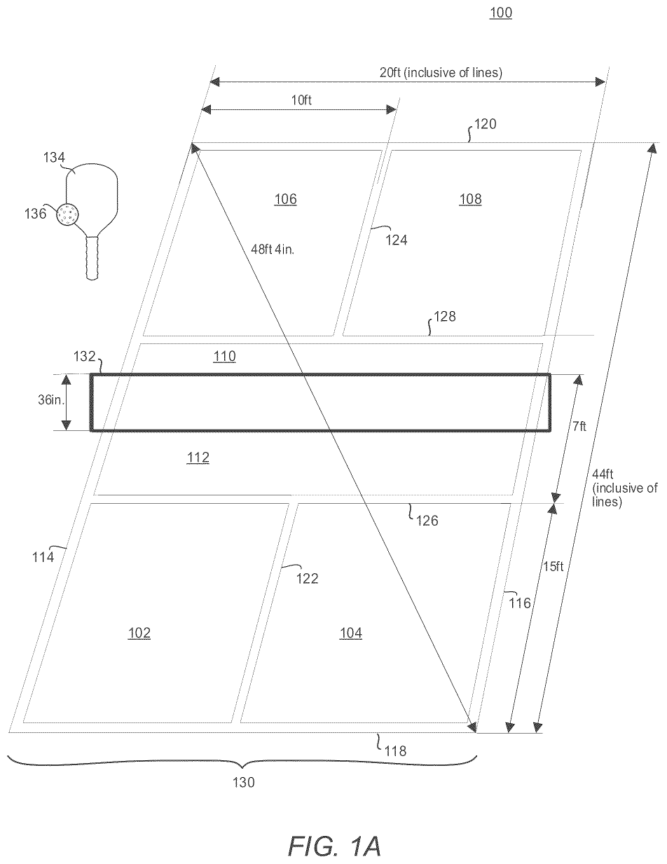

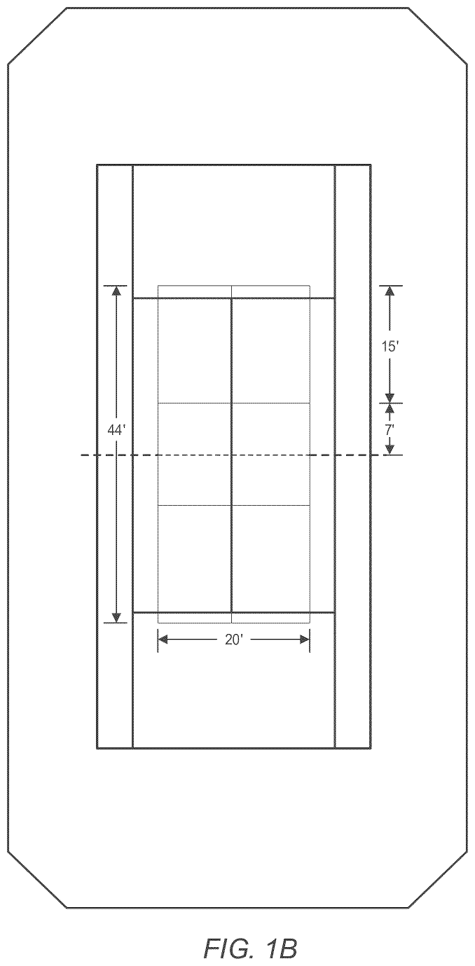

FIG. 1A shows an example pickleball court 100 that includes a pickleball playing surface 130 and a pickleball net 132. The playing surface 130 comprises two left serve areas 102 and 108, two right serve areas 104 and 106, and two non-volley areas 110 and 112, with one of the left serve areas, one of the right serve areas, and one of the non-volley areas being on each side of the pickleball net 132. The net is 36 inches tall at the edges, and lowered to 34 inches in the middle. The areas 102-112 are defined by baselines 118 and 120 each 20 feet, sidelines 114 and 116 each 44 feet, center lines 122 and 124 each 15 feet, and non-volley lines 126 and 128 each the same size as a baseline. Each of the lines may be 2 inches wide. The term “court line” is used in this disclosure to refer to any sideline, baseline, centerline or non-volley line on the pickleball court. Non-volley areas 110 and 112, each extending 7 feet from the net, are also referred to as the “kitchen”.

The game of pickleball is played with a pickleball paddle 134 and pickleball ball 136. The ball 136 is typically made of plastic and has a 3-inch diameter. Similar to a wiffleball, the ball 136 has through holes throughout the surface. Different types (e.g., with different levels of hardness and different sizes of the through holes) may be used for playing the game on the various types of pickleball courts (e.g., indoor, outdoor, hard surface, soft surface etc.).

Pickleball can be played as singles or doubles, and is most commonly played as doubles. Each point begins with an underarm serve. The serve is performed diagonally beginning at the right-hand service square. A valid serve sends the ball from one left serve area to the other left serve area or from one right serve area to the other right serve area. The serve must clear the non-volley-zone. The serve must bounce before being hit by the receiver. The return of serve must also bounce before being hit (this is known as the 2 bounce rule). After the serve and the return of the serve, the ball can land anywhere on the opposite side of the playing surface 130. Volleys can only be performed outside of the non-volley zone. Volleys, that is, hitting the ball in the air without first letting it bounce, can only be made after the 2 bounce rule has been followed. However, if the ball is hit from within the kitchen, then it cannot land in the kitchen on the other side of the net.

A fault is any action that stops play due to a rule violation. A fault by the receiving team results in the servers earning a point. A fault by the serving team results in the server's loss of service and/or side out. A fault is committed when the serve touches any part of the non-volley zone (including the line) or the ball is hit out of bounds.

Pickleball games are typically played without a referee and are self-judged. Each player makes the line calls as to whether the ball is in or out when the ball contacts the playing surface on that player's side. The game continues to at least 11 points and requires a 2-point difference for a win. FIG. 1B shows another view of a pickleball court.

Pickleball courts are often crowded even for recreational play, with sets of players waiting to play. In many tournament settings, sets of players are assigned to courts and with games typically only taking 20-30 minutes apiece, it is often the case that several sets of players line up for the same court or set of courts. Each set of players may have two or four players, depending on whether singles or doubles play is taking place.

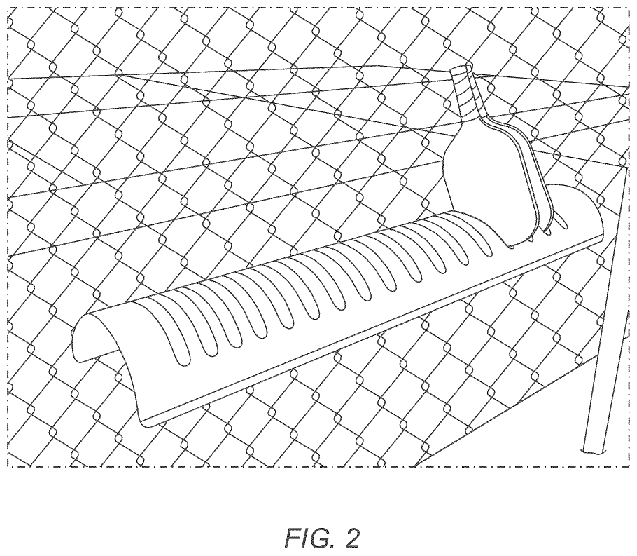

A conventional pickleball paddle holder is shown in FIG. 2. A conventional pickleball paddle holder, as shown in FIG. 2, has a plurality of pickleball paddle holding slots arranged in a row. The pickleball paddle holder can be located adjacent to the pickleball court or any other location that is convenient for players who are about to play a game on the pickleball court.

In recreational play or in open-play settings, a common practice is for each set of players to place their paddles in a pickleball paddle holder according to a sequence. In a recreational setting, the ordering may be based on the time of arrival at the court for each of the sets of players. As each group arrives at the court, they may place their paddles starting at the empty slot that is nearest to a designated paddle retrieval end of the paddle holder. The next set of players to have the court is the set who are nearest to the paddle retrieval end. Thus, when the set of paddles nearest to the paddle retrieval end is retrieved by the players who own them, the other paddles already in the holder are manually moved up closer to the retrieval end.

In the conventional pickleball paddle holders as in FIG. 2, shifting the pickleball paddles is manual and is extra work. For example, one person shifting a pickleball paddle to be nearer to the retrieval end, is expected to shift all other pickleball paddles in the paddle holder and, in the process, touch other people's pickleball paddles. Some players do not like their pickleball paddle to be touched by others.

Is some conventional pickleball paddle holders, when a set of pickleball paddles are removed from the paddle holder to start a game in an available court, then a “next up” label is shifted to the pickleball paddle (or group of pickleball paddles) that are up for the next game. This mechanism is confusing to some players as not everyone has the same understanding of who plays next after the next players (above “up next” label) go and start a game. Some people leave “up next” label to the left, and some move it to the right. Sometimes players move the label “up next” under their paddle, as they think they are the next players, while they are not thereby unintentionally causing confusion/conflict among players to arise. Sometimes the label “up next” is shifted inaccurately to a wrong pickleball paddle, and that can create confusion/conflict among players. The concept of rotational order may be implemented but it is not understood by some players.

Conventional pickleball paddle holders exist in which each holding slot is configured to hold the striking blade of the paddle and others exist in which the holding slot holds the handle. They exist as devices that are placed at ground level, or in which the paddles are held on a platform.

Example embodiments of the present disclosure provide pickleball paddle holders with a movable surface that greatly simplifies maintaining of the player “up next” ordering, that removes the need to manually move the paddles, that provides an ease of placing and retrieving the paddle as similar to a conventional apparatus such as that shown in FIG. 2, and that avoids the problem of paddles being touched by many persons when they are in the paddle holder.

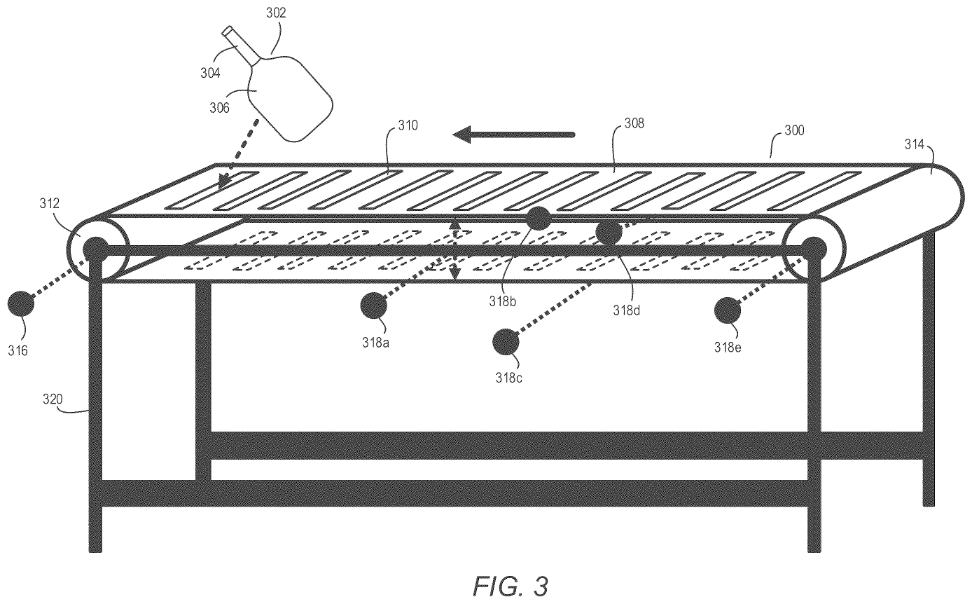

FIG. 3 shows a pickleball paddle holder 300 having a movable surface 308, in accordance with some embodiments of the present disclosure.

The pickleball paddle holder 300 comprises a movable surface 308 extended between two end objects 312 and 314. The movable surface 308 comprises a plurality of pickleball paddle hold locations 310 and is configured to move laterally in the right-left direction with the left end being the designated paddle retrieval end. Alternatively, the movable surface may be configured to move laterally in the left-right direction, with the right end being designated as the paddle retrieval end. In order to provide the “table” function and look-and-feel that many players are familiar with via conventional pickleball paddle holders such as that shown in FIG. 2, the upper portion of the movable surface, the lower portion of the movable surface, and the end objects are deployed on a same vertical plane. In the example illustrated embodiment, the two end objects are configured to be at the same height from ground.

In some embodiments, the movable surface 308 comprises a belt that is, directly or indirectly, in contact with each of the two end objects 312 and 314. The movable surface 308 may be constructed from a flexible material and may be stretched between the two end objects 312 and 314. The movable surface 308 may be a continuous belt that snugly contacts each of the end objects 312 and 314 on a side of each end object's circular surface. The thickness of the movable surface may be, in some embodiments, sufficient to provide an adequate depth to hold an inserted paddle (e.g., 1-5 inches).

In some embodiments, the two end objects 312 and 314 comprise rollers that are configured to rotate when the movable surface 308 is moved. The rollers have a rotating axis that is perpendicular to the moving direction of the movable surface 308. The pickleball paddle holder 300 can be configured to cause the movable surface 308 by rotating an end object 312 or 314, and/or cause the end objects 312 and 314 to move by moving the movable surface 308.

The movable surface 308 comprises a plurality of paddle hold locations 310. Each paddle hold location 310 is configured to hold one pickleball paddle 302. The paddle 302 is held by its striking blade 306 such that the handle 304 is at a higher level than the striking blade 306. In some embodiments, each paddle hold location 310 may be an opening through the movable surface 308 (i.e., open at the top and through the bottom of the movable surface) configured to snugly hold the striking blade 306. For example, the opening may have an inner surface padded with a flexible material on the sides so that the inserted portion of the striking blade pushes against the padding and is snugly held by the padding. In another example embodiment, the inserted striking blade can be held by a locking mechanism that can automatically lock the striking blade in place when inserted into the opening and can release the lock when pressure is exerted to retrieve the paddle. In another embodiment each opening may include a recession on the moving surface 308 that is closed at the bottom and the paddle is held in place by the inner walls of the opening and supported by a bottom layer of the moving surface 308. Each opening 310 may be a narrow elongated opening sized to fit the striking blade of a paddle. As shown in the illustrated embodiment, the paddle hold locations 310 are positioned throughout the moving surface 308, but only the paddle hold locations that are on the portion of the moving surface 308 that is above the two end objects are capable of holding paddles. Having a paddle held by paddle hold location that is a recession in the moving surface itself or by a paddle hold structure within the confines of the lateral edges (edges in the direction perpendicular to the moving direction) of the moving surface and above the two end objects provide for a more compact apparatus and reduces the chances of external elements striking the paddle and causing damage. Moreover, the paddles themselves, when held in the paddle hold locations, can entirely be, or can have a majority of their surface area, within the confines of the lateral edges of the moving surface. The majority of the surface area of a paddle means the majority (e.g., above 50%, above 75%, or above 90%) of the surface area of the striking blade or the majority of the area of the striking blade and the handle of the paddle. For example, in the illustrated embodiment in FIG. 3, the moving surface, the end objects, all paddle hold structures, and, all paddles that are held by the upper portion of the moving surface, are within the confines of the moving surface and a base or stand 320.

The paddle hold locations 310 may be arranged throughout the movable surface, and at any given point in time, the paddle hold locations 310 above the level of the end objects 312 and 314 are capable of holding pickleball paddles. The portion of the moving surface 308 that can hold pickleball paddles at a given time may be referred to as the upper movable surface 308. As described above, one or more embodiments provide paddle hold locations that do not include any clamp, lock or other such mechanism to firmly hold the paddles. In such embodiments, a paddle may be retrieved from its paddle hold location by movement in the direction opposite to the insertion direction without any resistance in that direction. This aspect, together with the table look-and-feel mentioned above may provide a pickleball holder that is more convenient to use.

In some embodiments, the pickleball paddle holder 300 is configured to have the movable surface 308 moved by a handle 316 attached to one of the end objects 312 or 314. In the illustrated embodiment, handle 316 is attached to the end object 312 at the retrieval end of the movable surface 308. The handle 316 may be of any shape and structure that enables convenient turning of the handle so that the upper movable surface 308 can be moved in the direction right-to-left (and/or alternatively in the opposite direction). Handle 316, when turned manually, turns end object 312 which in turn causes the movable surface 308 to move thereby moving the arrangement of paddles held in the paddle hold locations 310 that are on the upper movable surface 308. Alternatively, or additionally, a handle 318e can be at the end object 314 at the far end. The handle 318e may operate the movable surface in the same manner as handle 316.

In some embodiments, alternatively or additionally to any other handle arranged on the pickleball paddle holder 300, one or more other handles may be configured at locations other than an at end object 312 or 314. For example, a handle can be configured to attach to the side or top of the movable surface as in locations 318a, 318b, 318c and 318d. At 318a and/or 318d a handle may be attached to the side of the movable surface 308 so that the handle can be gripped by hand and moved in the direction of intended movable surface movement. At 318b and/or 318c, a handle can be constructed as a structure on the movable surface that can be gripped by hand and moved.

In some embodiments, the pickleball paddle holder 300 may be configured to move the surface so that the moving of the surface stops/pauses and restarts as each paddle hold location approaches the retrieval end. This behavior would lessen the prospects of damaging the striking blade of the paddle in a paddle hold location that comes in contact with the end object 312 at the retrieval end or of damaging paddles by allowing them to fall off when the corresponding paddle hold locations 310 are moved over and beyond the end object 312. A mechanism to stop or pause the moving of the movable surface 308 and then restart may be implemented in one of the end objects 312 or 314 by, for example, a latch that engages at a preconfigured turn distance of the end object and then releases when further pressure is applied in the same direction.

The thickness of the movable surface 308 may be configured so that each paddle hold location 310 can hold the striking blade 306 with sufficient force to enable the paddle 302 to stay upright (or, if so positioned, at an angle) as the movable surface 308 is moved. The number of paddle hold locations 310 arranged on the movable surface 308 may vary depending on the distance between the two end objects, or the length or the upper movable surface 308.

The pickleball paddle holder 300 may include a base or stand 320 that elevates and positions the movable surface 308 to a height that is convenient for players to place and retrieve paddles from the paddle hold locations 310 on the movable surface 308. The two end objects 312 and 314 may be at the same height.

Compared to conventional pickleball paddle holders such as the paddle holder shown in FIG. 2, the pickleball paddle holder 300 reduces the manual work required to move many paddles each time the “next up” set of paddles are retrieved from the paddle hold locations nearest the retrieval end, reduces player confusion and player errors by taking the player out of manually moving the remaining paddles, and increases safety and comfort levels for players by reducing other persons coming in contact with a player's paddle. Additionally, by enabling the paddle to be held such that the butt caps on the handles of paddles can be seen when the movable surface is moved, it is made easier for all to quickly determine when someone is up for play.

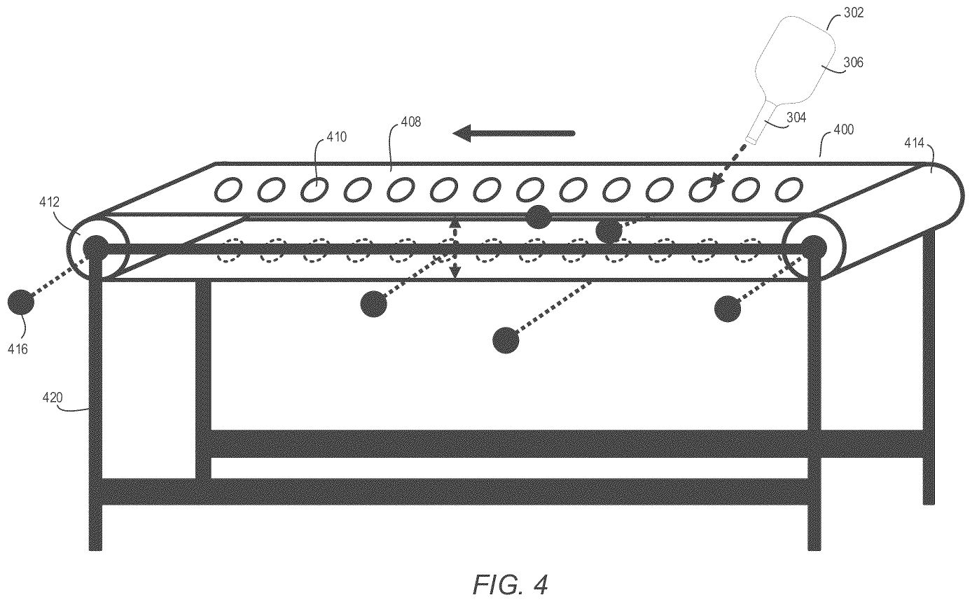

FIG. 4 shows another pickleball paddle holder having a movable surface, in accordance with some embodiments of the present disclosure. Pickleball paddle holder 400 may be similar in structure and operation to pickleball paddle holder 300 described in relation to FIG. 3, with the exception that, in pickleball paddle holder 400 the paddle hold locations 410 are configured to hold the paddles 302 by their handles 304. Each paddle hold location 410 on the movable surface 408 may be a circular opening that enables a handle 304 to be inserted and held in place.

In some embodiments, the openings on the paddle hold locations 410 are through the movable surface. In some embodiments, each circular opening may or may not include a padding of flexible material or locking mechanism to hold the handle in place. Handle 404 can be inserted into the opening so that the sides of the striking blade 406 rests on the movable surface, thereby holding the inserted paddle in place without additional support of flexible padding or a locking mechanism. Alternatively, the openings may include padding and/or locking mechanism to more steadily hold the handles of paddles. Moreover, in some embodiments the locations 310 have an opening at the top of the movable surface and a bottom of the opening is closed at the bottom layer of the movable surface, and the paddle handle is held by the force exerted by the side walls of the opening and supported by bottom layer of the movable surface. As noted above with respect to FIG. 3, having the paddle hold locations as openings within the confines (edges) of the movable surface facilitates reducing damage to paddles and also a more compact paddle holder apparatus.

Aspects of the structure, construction and operation of the movable surface 408 and end objects 412 and 414 may be identical or similar to that of the corresponding components 308, 312 and 314, respectively, of the pickleball paddle holder 300. Base or stand 420 may be identical or similar to base or stand 320. Pickleball paddle holder 400 may have one or more handles 416 or 418a-d which may be identical or similar to handles 316 and 318a-d of FIG. 3.

Pickleball paddle holder 400, as noted above, does not require additional padding or locking mechanisms to hold the paddles in the openings at each paddle hold location 410. Therefore, pickleball paddle holder 400 may be implementable with a moving surface of smaller thickness than pickleball paddle holder 300.

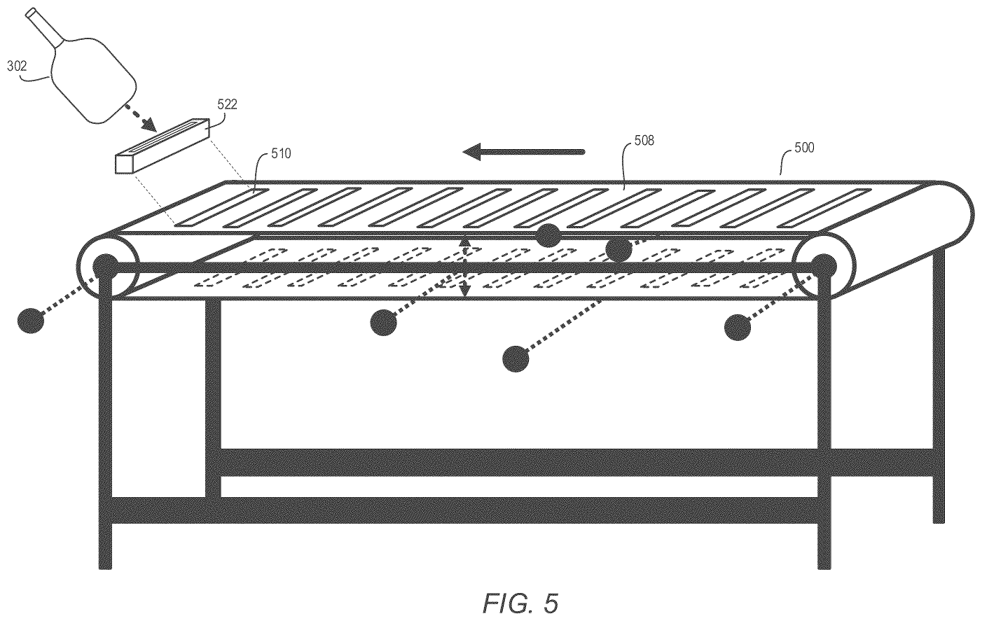

FIG. 5 shows another pickleball paddle holder having a movable surface, in accordance with some embodiments of the present disclosure. Pickleball paddle holder 500 may be similar in structure and operation to pickleball paddle holder 300 described in relation to FIG. 3, with the exception that, in pickleball paddle holder 500 the paddle hold locations are configured to hold the paddles 302 by inserting their striking blades 306 in structures 522 that are formed on each hold location 510 on the movable surface 508. Each structure 522 may protrude upward from the movable surface 508 and have an opening that is dimensioned to snugly hold the striking blade 306.

The opening on structure 522 may or may not have padding of a flexible material on its internal surface to enhance the fit of the paddle in the opening. For example, in some embodiments, the opening may be configured to steadily (snugly) hold the striking blade by itself in combination with the internal walls of the structure. In some embodiments, the opening may be dimensioned to be larger than the striking blade and flexible padding on the internal walls may enable the striking blade to be held by force of the surrounding padding when inserted in the opening.

Aspects of the structure, construction and operation of the movable surface 508 and end objects 512 and 514 may be identical or similar to that of the corresponding components 308, 312 and 314, respectively, of the pickleball paddle holder 300. Base or stand 520 may be identical or similar to base or stand 320. Pickleball paddle holder 500 may have one or more handles 516 or 518a-d which may be identical or similar to handles 316 and 318a-d of FIG. 3.

In some embodiments the structure 522 may have the bottom end open to an opening on the corresponding hold location 510 on the moving surface such that the inserted striking blade partially contacts the sides of the openings in the structure 522 and in the moving surface 508.

The base, handles and the operation of the moving surface in pickleball paddle holder 500 may be similar or identical to that of pickleball paddle holder 300.

By having structures 522 for holding the striking blades and/or providing additional support to the movable surface 508 to hold the striking blades, the movable surface 508 pickleball paddle holder 500 may have movable surfaces of less thickness than, for example, pickleball paddle holder 300.

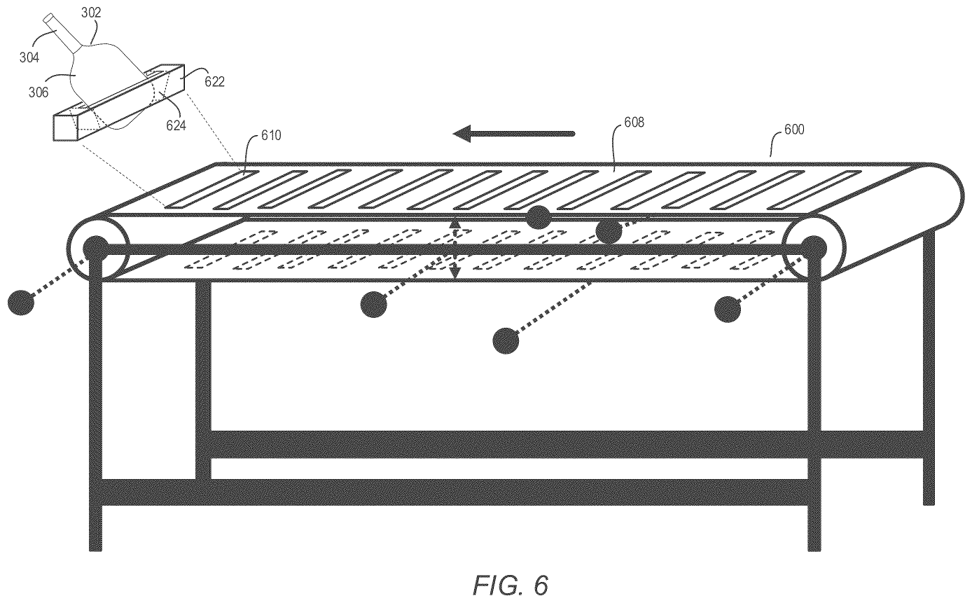

FIG. 6 shows another pickleball paddle holder having a movable surface, in accordance with some embodiments of the present disclosure. Pickleball paddle holder 600 may be similar in structure and operation to pickleball paddle holder 500 described in relation to FIG. 5, with the exception that, in pickleball paddle holder 600 the paddle hold locations are configured to hold the paddles 302 by inserting their striking blades 306 in structures 622 that are formed on each hold location 610 on the movable surface 608 in such a manner that part of the striking blade 306 protrudes below the bottom edge of the upper movable surface 608. Moreover, structure 622 is configured to have the paddle inserted at an angle so that the butt cap of the handle is more easily visible at eye-level.

The internal walls 624 of the opening in structure 622 may be configured to enable insertion of the paddle 302 at an angle and holding it in place such that one edge of the striking blade 306 rests against a sloped surface of the internal wall 624 at one end of the opening and another part of the edge of the striking blade rests on the sloped internal wall 624 on the opposite side of the opening. When fully inserted, a part of the striking blade 306 protrudes below the bottom end of the upper part of the moving surface 608.

Pickleball paddle holder 600 enables the butt caps to be more easily visible at eye level thereby making identification of players and their relative playing order more convenient. Moreover, having a portion of the striking blade protrude below the upper moving surface enables various paddle presence/absence detection mechanisms to be implemented in the space between the upper movable surface and the lower movable surface.

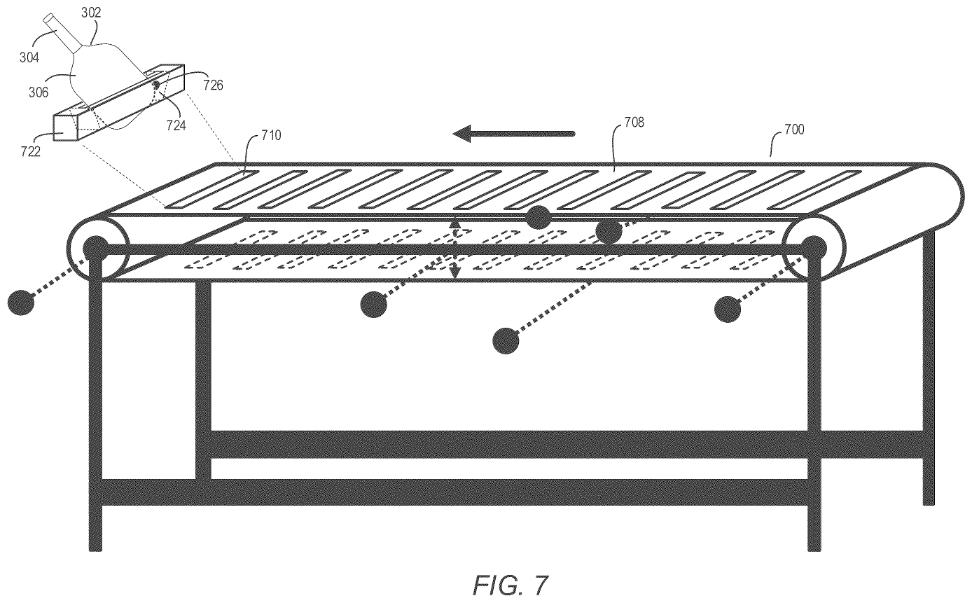

FIG. 7 shows another pickleball paddle holder having a movable surface, in accordance with some embodiments of the present disclosure. Pickleball paddle holder 700 may be similar in structure and operation to pickleball paddle holder 600 described in relation to FIG. 6, with the exception that, in pickleball paddle holder 700 the paddle hold locations 710 and/or the corresponding structures 722 include a sensor 726 to detect the presence or absence of a paddle 302 in the paddle hold location 710. The sensor 726 may be located on an internal surface 724 of the opening at a paddle hold location 710, and may be a pressure sensor.

In some embodiments, a detection signal from the sensor 726 indicating a presence of a paddle in the structure 722 on hold slot 710 that is nearest the retrieval end can trigger a stopping mechanism. For example, such a detection of a presence of a paddle, can engage a latch in the end object at the retrieval end to pause the moving until the presence detection signal is cleared (e.g., by removing the paddle from the structure 722 at the hold slot 710 nearest the retrieval end. In some embodiments, such a presence detection signal can generate an audible or visible signal to cause the person moving the movable surface 708 to stop the moving.

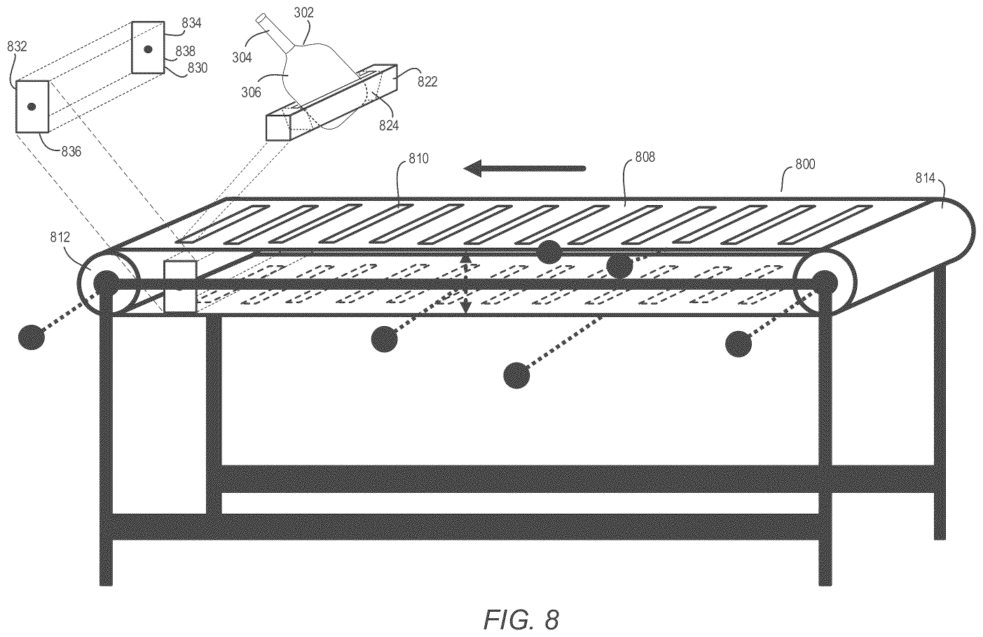

FIG. 8 shows another pickleball paddle holder having a movable surface, in accordance with some embodiments of the present disclosure. Pickleball paddle holder 800 may be similar in structure and operation to pickleball paddle holder 600 described in relation to FIG. 6, with the exception that, in pickleball paddle holder 800 the paddle hold location 810 nearest the retrieval end (i.e. closest to end object 812) has sensors 836 and 838 arranged in between the upper and lower portions of the moving surface 808 such that the presence or absence of a paddle 302 in that hold location can be detected by the sensors 836 and 838.

The sensor transmitter 836 and sensor detector 838 may be affixed to panels 832 and 834 that are arranged on either side of the paddle hold slot 810 orthogonally to the moving direction of the movable surface 808. In an example embodiment the panels 832 and 834 can be fixed to the base or stand that holds the end objects 812 and 814.

In an example embodiment, the sensors 836 and 838 provide an optical sensor. When a paddle is inserted into a structure 822 such that a part of the strike blade 306 protrudes below the upper movable surface 808 (e.g., by holding the striking blade at an angle supported by an inner wall 824 in the opening of structure 822) and the paddle hold location 810 having that inserted paddle comes in contact with the optical beam between sensors 826 and 838 at the hold location 810 nearest the retrieval end, the sensors detect the presence of the paddle in the near the retrieval end and can trigger actions as described in relation to FIG. 6 above to prevent damage to the paddle.

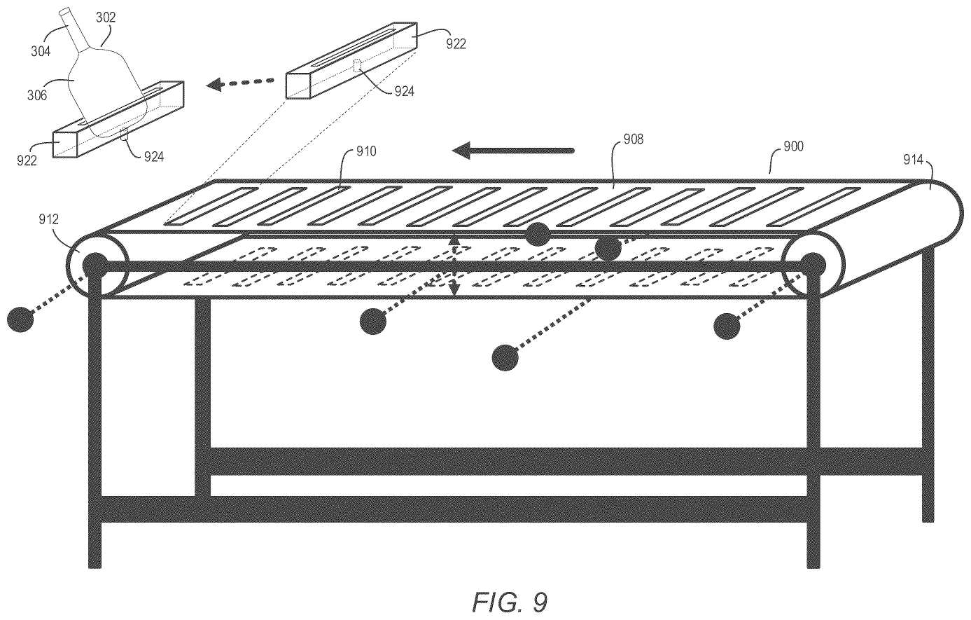

FIG. 9 shows another pickleball paddle holder having a movable surface, in accordance with some embodiments of the present disclosure. Pickleball paddle holder 900 may be similar in structure and operation to pickleball paddle holder 800 described in relation to FIG. 8, with the exception that, in pickleball paddle holder 900 each paddle hold location 910 includes a structure 922 that has a spring-loaded object 924 that, when a paddle 302 is inserted so that the paddle presses down on object 924, protrudes downward so that it (object 924) protrudes below the bottom of the upper moving surface 908. When the opening of the structure 922 does not have a paddle inserted, the object 924 does not protrude below the below the bottom of the upper moving surface 908.

Based on whether the object 924 of the paddle hold location 910 nearest to the retrieval end is protruding below the bottom of the upper moving surface 908, an optical sensor such as that described in relation to FIG. 8 can determine the presence of absence of a paddle in paddle hold slot nearest the retrieval end and trigger damage prevention actions as described in relation to FIGS. 7 and 8.

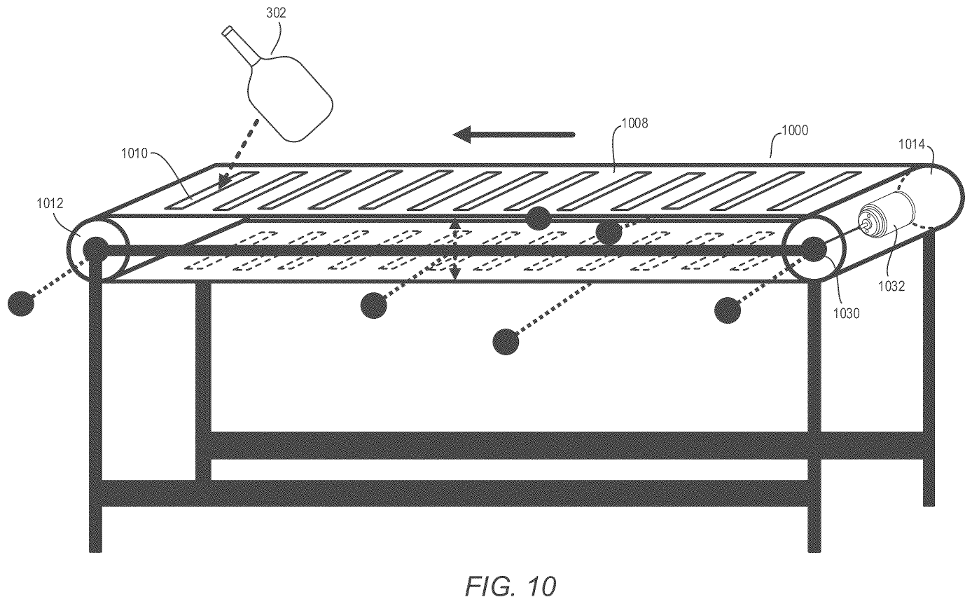

FIG. 10 shows a pickleball paddle holder having a movable surface, in accordance with some embodiments of the present disclosure. Pickleball paddle holder 1000 may be similar in structure and operation to any of the pickleball paddle holders 300, 400, 500, 600, 700, 800 or 900 described above in relation to respective FIGS. 3-9, and illustrates an example motor and power arrangement 1032 to automatically move the movable surface 1008.

In some embodiments, the motor and power arrangement 1032 comprises a motor that engages at least at one side 1030 of the end object 1014 to rotate the end object 1014 by the force of the motor. The motor and power arrangement 1032 may include a power source (e.g., battery) or may include a power management arrangement that is connectable to an external power source such as a battery or an AC power source to power the motor and any other electrical components such as sensors, etc. The motor, by causing the rotation of end object 1014, causes the movable surface 1008 having paddle hold locations 1010 arranged thereon to move and end object 1012 to rotate.

In some embodiments pickleball paddle holder 1000 includes structures 722, 822 or 922 and a sensor arrangements described in relation to pickleball paddle holder 700, 800, or 900.

In some embodiments, the motor 1032 is activated by a user manually pressing a switch, and is stopped by releasing the switch. Alternatively or additionally, the motor may be automatically halted by a sensor such as that described in relation to FIGS. 7-9 detecting the presence of the paddle in the paddle hold slot 1010 nearest the retrieval end. In some embodiments, the pickleball paddle holder 1000 may be configured to automatically keep moving the belt until paddle hold location nearest the retrieval end is detected to have an inserted paddle.

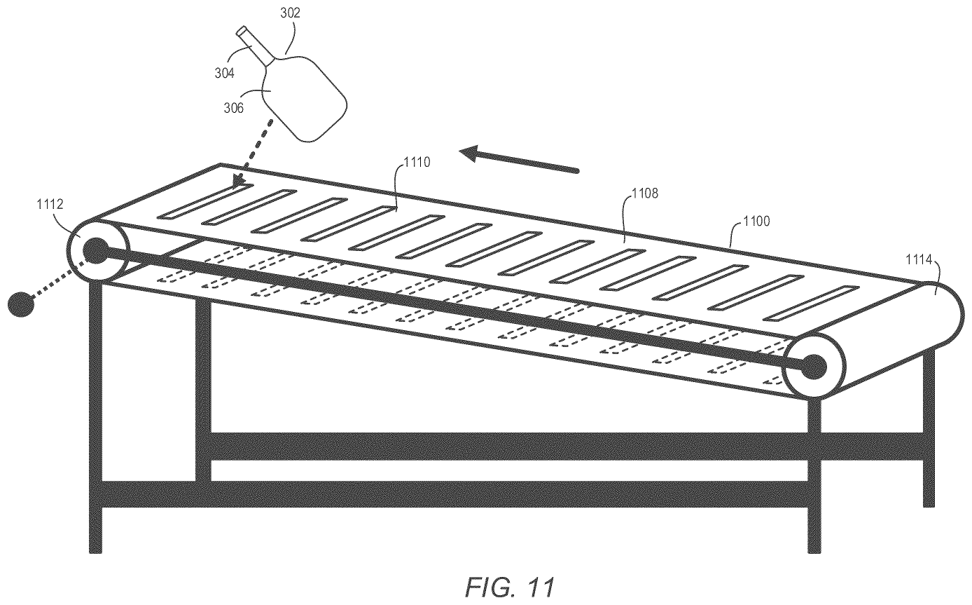

FIG. 11 shows a pickleball paddle holder having a movable surface, in accordance with some embodiments of the present disclosure. Pickleball paddle holder 1100 may be similar in structure and operation to any of the pickleball paddle holders 300, 400, 500, 600, 700, 800, 900 or 1000 described above in relation to respective FIGS. 3-10, and may, instead of having both end objects at the same height, have the retrieval end 1112 at a higher elevation than the other end 1114. This enables having a longer movable surface 1110 in the same distance between the end objects as the other pickleball paddle holding arrangements in the above described embodiments. A longer movable surface provides for having more hold locations 1110 arranged for the same floor space as in the above described embodiments.

Embodiments of the present disclosure are not limited to the embodiments described in relation to FIGS. 3-11. Additional embodiments may be formed by combining, into any one of the embodiments described in relation to FIGS. 3-11, one or more features from any of the other embodiments. For example, any one of the embodiments 3-9 and 11 may include the motor and power arrangement of, or similar to, that described in relation to FIG. 10. Many of the above described embodiments provide a standalone and portable pickleball holder apparatus. Being a standalone device enables the apparatuses of example embodiments to be deployed without interfering with any of the infrastructure at the respective locations. Moreover, coupled with the portability of example embodiments, the apparatuses of example embodiments provide a cost-effective means of managing paddles in play-order at pickleball sites. Moreover, in order to provide the “table” function and look-and-feel with which many players are familiar with via conventional pickleball paddle holders such as that shown in FIG. 2, the upper portion of the movable surface, the lower portion of the movable surface, and the end objects in example embodiments may be deployed on a same vertical plane.

Moreover, having the paddle held by paddle hold location that is a recession or opening in the moving surface itself or by a paddle hold structure within the confines of the lateral edges (edges in the direction perpendicular to the moving direction) of the moving surface provide for a more compact apparatus and reduces the chances of external elements striking the paddle and causing damage. The paddles themselves, when held in the paddle hold locations, are entirely, or have a majority of their area, within the confines of the lateral edges of the moving surface. In some examples, they may be held in a manner that their butt caps, which many players use to uniquely identify their paddle, is clearly visible.

In some example embodiments described above, the sensor or sensors that provide for automatically stopping the moving surface when the paddle hold location that is next to an end object in the moving direction is occupied, are also incorporated within the confines (edges) of the moving surface and the optional base or stand. The sensors can moreover be positioned entirely within the internal space formed between the upper and lower portions of the moving surface in between the end objects, thereby being completely contained within the apparatus and having a lower likelihood of being subject to damage.

Moreover, as described above, one or more embodiments provide paddle hold locations that do not include any clamp, lock or other such mechanism to firmly hold the paddles. In such embodiments, a paddle may be retrieved from its paddle hold location by movement in the direction opposite to the insertion direction without any resistance, or without any substantial resistance that would be more than that felt by a player using a conventional device such as that in FIG. 2, in that direction. The lack of any clamp, lock or other such mechanism to firmly hold the paddles may be observed as, in such embodiments, a paddle that is inserted into a paddle hold location that is on the lower portion of the moving surface is not held in place and would instantly freely fall off from the paddle hold location. This aspect, together with the table look-and-feel mentioned above may provide a pickleball holder that is more convenient to use.

The above described embodiments provide improved pickleball paddle holders with movable surfaces. It should be noted that embodiments of the present disclosure are not limited to the shapes, lengths or construction materials of the handles, strike blades, or butt caps of the pickleball paddles. Although various embodiments have been shown and described in detail, the claims are not limited to any particular embodiment or example.

1. A standalone pickleball paddle holding system comprising a movable surface with a plurality of pickleball paddle hold structures formed on the movable surface, wherein the movable surface is configured to move between two fixed end objects, and the pickleball paddle hold structures in an upper portion of the movable surface that is above and between the two fixed end objects are each configured to hold a respective pickleball paddle such that at least a majority of the respective pickleball paddle is positioned between the lateral edges of the upper portion of the movable surface.

2. The standalone pickleball paddle holding system according to claim 1, wherein the standalone pickleball paddle holding system is portable.

3. The standalone pickleball paddle holding system according to claim 1, wherein at least one of the pickleball paddle hold structures is configured to hold a pickleball paddle by the striking blade in a manner that a bottom of a handle of the pickleball paddle is visible.

4. The standalone pickleball paddle holding system according to claim 3, wherein the at least one pickleball paddle hold structure is configured to hold the pickleball paddle without clamping any portion of the paddle.

5. The standalone pickleball paddle holding system according to claim 3, wherein the at least one pickleball paddle hold structure is configured to hold the pickleball paddle without imposing a substantial resistance to movement of the pickleball paddle in a direction opposite to an insertion direction of the pickleball paddle into the at least one hold structure.

6. The standalone pickleball paddle holding system of claim 1, wherein the movable surface comprises an upper movable surface positioned above the end objects and a lower movable surface positioned below the end objects, the upper movable surface and the lower movable surface being arranged in a vertical plane, and wherein the paddle hold structures are arranged throughout the moving surface, at a particular time, paddle hold structures on the upper movable surface are capable of holding pickleball paddles and the paddle hold structures on the lower movable surface are incapable of holding pickleball paddles.

7. The standalone pickleball paddle holding system of claim 1, wherein the movable surface is configured to be moved by an electric motor, and wherein the electric motor is actuated by a sensor to automatically move the surface when paddles are removed from one or more pickleball paddle hold structures nearest to a first one of the end objects.

8. The pickleball paddle holding system of claim 7, configured to stop the electric motor when an optical sensor or a pressure sensor senses that the pickleball paddle hold structure nearest to the first one of the end objects is occupied.

9. The standalone pickleball paddle holding system of claim 8, wherein the sensor is configured to sense a presence of a protruding object when the pickleball paddle hold structure nearest to the first one of the end objects is occupied.

10. The standalone pickleball paddle holding system of claim 9, wherein the protruding object is a striking blade of a pickleball paddle occupying the pickleball paddle hold structure nearest to the first one of the end objects.

11. The standalone pickleball paddle holding system of claim 10, wherein the protruding object is a spring-loaded part configured to protrude from a bottom of the pickleball paddle hold structure when a pickleball paddle occupies the pickleball paddle hold structure and automatically return to an original position when the pickleball paddle hold structure is not occupied.

12. The standalone pickleball paddle holding system of claim 1, wherein the movable surface is configured to be moved using a handle to turn one of the end objects causing the movable surface to move.

13. The standalone pickleball paddle holding system of claim 12, wherein the handle is attached to the movable surface.

14. The standalone pickleball paddle holding system of claim 1, wherein the movable surface is a belt, and wherein the belt is configured to move in a circular motion between the two end objects.

15. The standalone pickleball paddle holding system of claim 1, wherein one or more of the pickleball paddle hold structures includes an opening in the movable surface for holding a pickleball paddle.

16. The standalone pickleball paddle holding system of claim 1, wherein one or more of the pickleball paddle hold structures includes a structure positioned on the movable surface and between edges of the movable surface for holding a pickleball paddle.

17. The standalone pickleball paddle holding system of claim 16, wherein the one or more of the pickleball paddle hold structures is configured to hold a pickleball paddle by a striking blade of the pickleball paddle.

18. The standalone pickleball paddle holding system of claim 17, wherein the one or more of the pickleball paddle hold structures is configured to hold a pickleball paddle by a handle of the pickleball paddle.

19. The standalone pickleball paddle holding system of claim 1, wherein the two end objects are at a same height.

20. The standalone pickleball paddle holding system of claim 1, wherein each pickleball paddle holding structure includes a spring-loaded object located at the bottom, and wherein the spring-loaded object located at the bottom is configured to indicate whether the corresponding pickleball paddle holding structure is occupied.
